(19) United States
(12) Patent Application Publication
(10) Pub. No.: US 2019/0207412 A1
(43) Pub. Date: Jul. 4, 2019

(54) Electricity Generator

(71) Applicant: Bradford Ivey, East Orange, NJ (US)

(72) Inventor: Bradford Ivey, East Orange, NJ (US)

(21) Appl. No.: 15/856,272

(22) Filed: Dec. 28, 2017

(51) Int. Cl. H02J 7/14

(52) U.S. Cl. CPC H02J 7/1423

(57) ABSTRACT

An electricity generator that draws power from a typical outlet or circuitry in a dwelling and creates and stores power in a battery bank that is converted to AC power by an inverter and is accessible via an AC power output by any device or circuitry requiring electricity for operation.

### CROSS-REFERENCE TO RELATED APPLICATIONS)

Not applicable

### BACKGROUND ON THE INVENTION

The field electrical generators is well established in the art. Most generators, however, utilize internal combustion engines and are not suitable to be operated inside a home or apartment style dwelling. Currently there exists a need in the art for an electrical generator able to power a small home, apartment or condominium-type residence that is able to be charged from a typical electrical outlet, and able to create power from a clean and safe source that does not produce hazardous and harmful exhaust or run on flammable petroleum-based fuel.

### BRIEF DESCRIPTION OF THE INVENTION

The present invention, in the preferred embodiment, is an electrical generator, small enough for utilization in a small home, apartment or condominium, that stores energy in batteries, similar to automobile batteries. This generator can be powered by a typical power outlet, and utilizes at least one small motor to produce the power that is stored in the batteries. The generator can be used as a stand-alone unit, with any electrical device being able to be plugged into the generator in the event of a power outage. The generator can also be hard-wired into the electrical circuitry of the dwelling, acting as a back-up power source in the event of a power outage.

In the preferred embodiment, the present invention is comprised of two motors and a series of batteries that exists in the enclosed device. There exists an inverter to convert the DC current produced by the batteries to AC current able to power the devices in the home. The motors powering the batteries are able to run on the AC current from the outlet or the home's circuitry or breaker if hard-wired into the residence. The present invention operates nearly silently, with little or no emissions. This device gives the consumer living in an apartment or condominium an efficient and affordable way to prevent food spoilage and other inconveniences that occur when power is lost.

### BRIEF DESCRIPTION OF THE DRAWINGS

FIG. 1 is a schematic depiction of the present invention. The components are: a power source input, 100; at least one motor, 200; a battery bank, 300; an inverter, 400; and an AC power output, 500, to act as a connection for electrical devices to connect to the invention.

### DETAILED DESCRIPTION OF THE INVENTION

In the preferred embodiment, the present invention is an electrical generator that utilizes power for a traditional power source, such as an outlet in a home or by direct connection to a home's circuit box, for the purpose of powering electrical devices in the event of a power outage. This device does not use petroleum or any other type of fuel, produces no carbon-based emissions, and is a clean and reliable source of energy for a condominium, apartment, or small home. It can be hard wired into the dwelling, or plugged into a typical electrical outlet.

In the preferred embodiment, the present invention draws electrical power from an outlet or the circuitry of a home or dwelling, and powers at least one motor to create the electricity that is stored in at least one battery or series of batteries. In the event of a power outage, the present invention can be activated. The present invention draws power from the battery or series of batteries in the battery bank, 300. An inverter, 400, is used to convert the DC current to AC current. Finally, the electricity is made available through the AC power output, 500, by either being hard wired into the circuitry of the living unit or via a typical outlet or outlets present on the invention whereby any electrically powered device can plug in and operate. This invention offers a clean and reliable energy source to power any device that requires electricity.

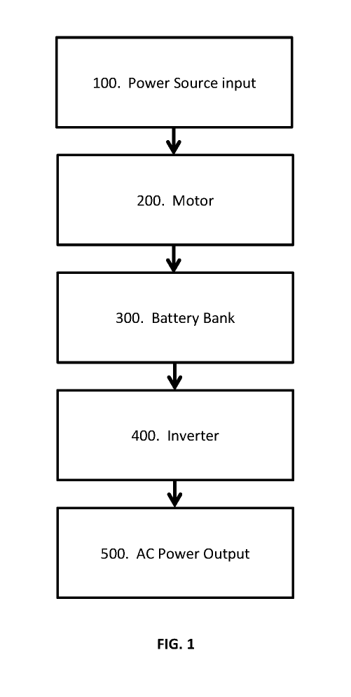

The present invention, in the preferred embodiment, utilizes a series of batteries in a batter bank, 300, in FIG. 1, optimally configured to store and subsequently produce as much electricity as possible in the event of a power outage. Lithium-ion technology could be implemented in order to extend the capacity of battery bank used in the present invention. In the preferred configuration, the present invention could power all the appliances in a small dwelling, apartment, condominium, or like living unit for up to 4 weeks or longer.

We claim:

1. An electrical generator comprising:
a power source input;
a motor;
a battery bank;
an inverter; and
an AC power output, whereby electricity is drawn into the device from the power source input that powers the motor to generate storable electricity that is stored in the battery bank and is converted to AC power through the inverter and accessible via the AC power output for the purpose of powering a device that requires electricity.

2. The method for generating electricity comprising:
drawing electricity into a device to power a motor;
creating and storing electricity by the motor into a battery bank;
converting the electricity to AC current through an inverter; and
accessing the electricity through an AC power output by a second device that requires electricity for operation.
